(19) United States
(12) Patent Application Publication
(10) Pub. No.: US 2019/0264950 A1
(43) Pub. Date: Aug. 29, 2019

(54) POWER SUPPLY SYSTEM FOR AN ELECTRICALLY POWERED RESISTIVE ELEMENT

(71) Applicant: SOLARHOTTY LIMITED, Newcastle Upon Tyne (GB)

(72) Inventor: Neill HUMAN, Strand (ZA)

(21) Appl. No.: 16/308,297

(22) PCT Filed: Jun. 9, 2017
(86) PCT No.: PCT/IB2017/053418

§ 371 Date: Dec. 7, 2018

(30) Foreign Application Priority Data
Jun. 9, 2016 (GB) 1610106.5

(51) Int. Cl. F24H 9/20; H02J 3/38; H05B 1/02; F24H 1/20

(52) U.S. Cl. CPC F24H 9/2021; H02J 3/385; H02J 9/062; H05B 1/0283; F24H 1/202; H02J 3/386

(57) ABSTRACT

A power supply system for an a.c. resistive element (10) comprises a first input point for an a.c. mains power source (14) and a second input point for d.c. power derived from photovoltaic panels and/or wind generators (24). Switches (18, 36) are provided between the power input points and the element (10). Timers (60, 62) are provided for delaying closing of that one of the switches (18, 36) that is open on change over from one power source to the other whereby the closed switch opens before the open switch closes. The voltage at the d.c. power input point is detected by a voltage sensor (42). The output from the sensor (42) powers an optical switch (46) which operates a relay (58) which in turn supplies power to one or other of the timers (60, 62) and one or other of the switches (18, 36).

### FIELD OF THE INVENTION

THIS INVENTION relates to a power supply system for an electrically powered resistive element.

### BACKGROUND TO THE INVENTION

Solar water heaters harness energy from the sun using evacuated tubes or flat plate collectors. This involves the transport of water or thermal heating fluid through a piped infrastructure between the heat collector and the hot water cylinder.

Evacuated tubes are manufactured from glass with a copper pipe running through the middle of the tube. All the air is removed from the glass tube in order to allow for maximum heat collection through radiation. These pipes can directly feed the hot water cylinder or can be part of a separate collector that feeds a hot water cylinder situated close to the collector.

Flat plate collectors are heat boxes with glass covers and copper pipes running through the heat boxes. These collectors function on the same principle as evacuated tubes, but with lower efficiencies and associated lower costs.

These collectors both operate on the same principle, collecting heat that is directly transferred to either water or a heat transfer fluid such as propylene glycol. Direct systems transfer heat directly to water that is circulated between the collector and the hot water system, whereas indirect systems transfer heat to the heat transfer fluid that is circulated through the hot water storage tank. The fluid is circulated either through an electric pump or through natural thermosyphoning. Where thermosyphoning is used, the hot water cylinder needs to be situated in close proximity to the actual collector and also above the collector in order for heated water to flow upwards into the hot water cylinder by means of natural convection.

Both of these systems therefore require a piping infrastructure which connects the collector with the hot water storage tank that may not be situated in close proximity to the actual collector. The collector has to be installed on the roof, requiring penetration of the roofing structure.

In specific installations, the ideal location for the collector may be far removed from the actual water storage tank, thus requiring excessive pipe runs to connect the two This can lead to significant heat losses associated with transporting heated water through the piping infrastructure and also adds to the total cost of installation.

In other installations photovoltaic solar panels generate electricity in the form of direct-current from solar radiation that can in turn be used to power various loads or recharge storage batteries. These panels make use of electrical wires that conduct electricity from the point of generation to the point of consumption, allowing for extensive piping lengths to be avoided in situations where the panels are far removed from the storage tank.

Both thermal collectors and photovoltaic panels are subject to the intermittent nature of solar energy that may or may not be available in accordance with the prevailing weather. The output will also differ during winter and summer with only a low number of usable solar hours per day in mid-winter.

The nature of hot water use in the residential market typically sees the occurrence of the main times of hot water usage in the early morning and late afternoons when full solar energy is not available. The nature of solar generation and of hot water usage demand therefore requires a supplementary source to provide heating capacity when solar energy is not available or is inadequate.

In order to ensure the availability of hot water irrespective of weather conditions, solar thermal water heaters typically also include an electrical resistive immersion heating element to be powered by alternating-current (AC) from the mains utility power when adequate solar energy is not available.

Photovoltaic panels that generate electrical energy can be used to power an electrical resistive heating element to heat water. This requires at least two elements to be included in the system in order to provide the backup requirement during poor solar conditions. One element is powered by the direct-current generated by the photovoltaic panels and the other heating element is powered by alternating-current supplied through the mains by the utility.

Heating elements currently used for water heating applications are suitable for a correctly sized photovoltaic array, but need to be isolated completely from the alternating-current supply to prevent hazardous electrical conditions arising and they cannot be allowed to operate using d.c and a.c power simultaneously.

The use of direct-current requires that more robust relays or switches be employed where high-voltage and high current operation can cause dc arcs that may damage the relay or switch. D.C relays are very expensive.

It will be understood that whilst the provision of water heaters powered by renewable energy sources is a prime object of the present invention, the system of the present invention can be used to provide power to any resistive power consuming device. Light sources and cooking plates are other examples of resistive devices which can be powered by the system of this invention.

Consequently, the main object of the present invention is to provide a power supply system which makes it possible to power a resistive element, which can be a resistive water heating element, a resistive space heater or any other device which runs on electrical power, from a.c and d.c supplies.

### BRIEF DESCRIPTION OF THE INVENTION

According to one aspect of the present invention there is provided power supply system for powering a resistive element, the system comprising:
a first power input point for connection to an a.c mains supply;
first terminals for connection to said element;
a first switch having a closed position in which said input point is connected to said terminals and an open position in which said input point is disconnected from said terminals;
a first timer for delaying closure of said first switch;
a second power input point for connection to a d.c source of electrical energy;
second terminals for connection to said element;
means for converting the d.c input at said second power input point to a.c power at said second terminals;
a second switch having a closed position in which said converting means is connected to said second terminals and an open position in which said converting means is disconnected from the second terminals;
a second timer for delaying closure of said second switch; and
a control circuit for detecting the presence of voltage at said second power input point and, upon the d.c voltage being detected being above a predetermined threshold level, in sequence opening said first switch and closing said second switch.

Said control circuit can comprise a light source which is supplied with power when the detected voltage exceeds said threshold level and a light sensitive switch which is actuated upon the light source being powered.

There can be an opto-coupler between said light source and said second power input point.

A two pole relay can be provided which is connected between a d.c power supply and said timers and which is switched between its two positions in dependence on whether said voltage is above or below said threshold level.

In the form of the system which includes the light sensitive switch, said relay is actuated between its two positions as said light sensitive switch opens and closes.

Said first and second switches can include operating coils connected through the first and second timers to said first power input point.

In a further form of the present invention a maximum power point tracker is provided, this using the d.c. input to provide the maximum power output that can be obtained based on the voltage and current available at said second power input point, switching between mains power and d.c. power being based on whether the power output of the tracker is above or below a predetermined threshold. In this form means can be provided for converting the output of the tracker to a form which simulates a.c.

According to a further aspect of the present invention there is provided an installation comprising a hot water cylinder having a resistive heating element therein, and a power supply system as defined above, said first and second terminals being connected to said element, said first power input point being connected to the mains and the second power input point being connected to a source of wind and/or solar generated d.c voltage.

According to another aspect of the present invention there is provided a method of supplying power to a resistive element, the method comprising monitoring the voltage available from photovoltaic panels and/or wind generators constituting a d.c source of power, connecting the d.c source to said element to power said element when the voltage available exceeds a predetermined threshold, disconnecting the d.c. source from said element when the voltage available falls below said threshold and connecting, after a delay period, a source of mains power to said element to power said element, disconnecting the mains power from said element upon the available d.c voltage exceeding said threshold and, after a delay, re-connecting the d.c. source to said element to power said element.

### BRIEF DESCRIPTION OF THE DRAWINGS

For a better understanding of the present invention, and to show how the same may be carried into effect, reference will now be made, by way of example, to the accompanying drawings in which;

FIG. 1 is a circuit diagram of a water heating system; and

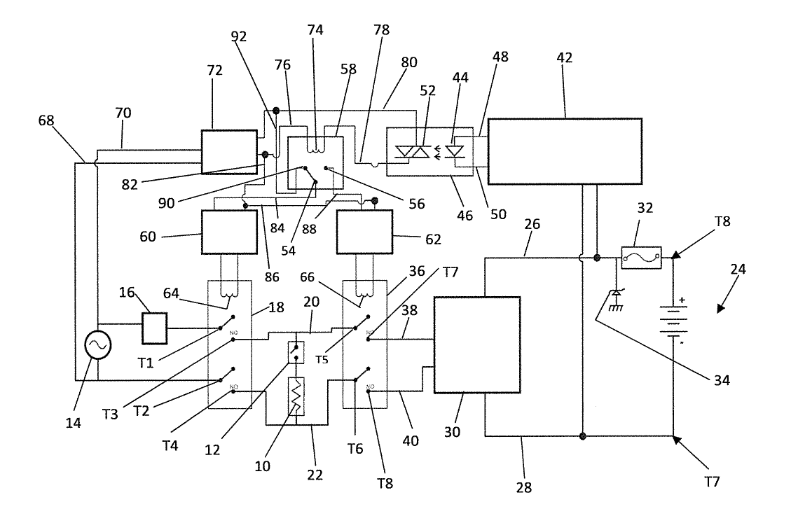

FIG. 2 diagrammatically represent a further water heating system.

### DETAILED DESCRIPTION OF THE DRAWINGS

Purely for the purposes of explaining the present invention, the following description pertains to a water heating system using a resistive electrical heating element. However, the element can be any electrically powered resistive element such as a space heater or a light source or the plate of a stove.

The water heating system illustrated powers a resistive heating element 10 immersed in the water in the hot water cylinder (not shown). The element can be of the PCT or NTC types. The element 10 is in series with a thermostat 12 which opens upon the water in the cylinder reaching a predetermined temperature.

The element 10 is powered from an a.c mains source 14 via a circuit breaker 16. The source 16 is connected to the movable contacts T1 and T2 of a double pole switch 18 and the fixed poles T3, T4 of the switch are connected to lines 20, 22 between which the element 12 and thermostat 14 are connected.

A second power source 24 is constituted by an array of series connected photovoltaic panels. The source 24 is connected by way of lines 26, 28 to an inverter 30 which converts the d.c output of the photovoltaic panels into a.c. There is a fuse 32 in the line 26 and the line 26 is connected to earth by way of a surge protector 34. The second power source can comprise wind generators or a combination of photovoltaic panels and wind generators.

The lines 20, 22 are connected to the movable contacts T5, T6 of a second double pole switch 36 and the inverter 30 is connected by lines 38, 40 to the fixed poles T7, T8 of the switch 36.

The voltage across the lines 26, 28 is sensed by a voltage sensor 42 which includes an opto-coupler. An output signal is generated which varies with the voltage across the lines 26, 28. Specifically, an output signal is only produced when the voltage across the lines 26, 28 exceeds a predetermined threshold.

The output signal of the sensor 42 is used to power a light emitting diode (LED) 44 of a optical switch 46 by way of lines 48, 50. The photosensitive sensor 52 of the switch 46 is illuminated by the LED 44.

The movable contact 54 and pole 56 of a relay 58 are respectively connected to timing circuits 60 and 62. The circuits 60 and 62 control power supply to the operating coils 64, 66 of the switches 18, 36.

Lines 68, 70 connect the a.c power source 16 to a rectifier 72 which provides a low voltage d.c output for powering the coil 74 of the relay 58 and the coils 64, 66 of the switches 18, 36.

A line 76 connects the rectifier 72 to the coil 74 of the relay 58. A further line 78 connects the coil 74 to the photosensitive sensor 52. The return line is designed 80. A line 82 connects the rectifier 72 to one terminal of the timer circuit 60 and the other terminal of the circuit 60 is connected by a line 84 to the movable contact 54. A further line 86 connects the two circuits 60 and 62.

The second terminal of the circuit 62 is connected by a line 88 to the pole 56. A second pole 90 of the relay 58 is connected to a line 92.

If it is assumed that there is little or no sunlight, and the water in the cylinder is cold, the switch 18 is closed and the element 10 is powered from the source 14. Power is supplied until the thermostat detects 12 that the water in the cylinder has reached its predetermined temperature and then opens. The movable contact 54 of the relay 54 is in the position shown to connect the rectifier 72 to the circuit 60 and to the coil 64 to hold the switch 18 closed.

When an increasing amount of sunlight falls on the panels of the source 24, or the wind increases if wind generators are used, the voltage is generated steadily increases. At a predetermined voltage level the sensor 42 operates and an output voltage is fed to the LED 44. The light sensitive switch 52 is illuminated and activated and this closes the circuit through the coil 74 of the relay 54. The contact 54 is displaced by the coil 74 into contact with the pole 56. Power supply to the coil 64 ceases and the switch 18 opens disconnecting the source 14 from the element 10.

The circuit 62, after a predetermined time interval, connects the coil 66 of the switch 36 to the rectifier 72. The switch 36 closes connecting the inverter 30 via the lines 38, 40, terminals T7 and T8 and switch 36 to the element 10.

Upon the amount of sunlight diminishing, and the voltage generated by the panels of the source 24 dropping, the signal to the LED 44 is terminated and the light sensitive switch 52 opens.

The coil 66 is immediately disconnected from the rectifier 72 so that the switch 36 opens. After a predetermined delay, the switch 18 closes to re-connect the source 14 to the element 10.

When the system is installed the terminals T3, T4 of the switch 18 and the terminals T5, T6 of the switch 36 are connected to the element. The terminals T1, T2 of the switch 18 are connected to the mains. The source 24 is connected across the terminals T7, T8 through the inventor 30.

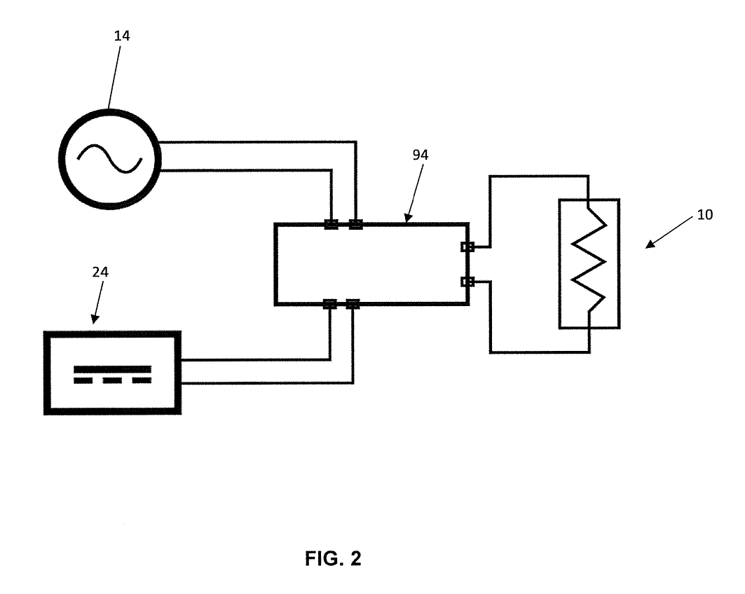

In FIG. 2 the reference numerals 10, 14 and 24 again represent a resistive element, the mains source of a.c. power and a second power source comprising photovoltaic panels.

Reference numeral 94 designates a programmable controller that constitutes the interface between the two power sources 14, 24 and the power consuming element 10.

A MPPT (maximum power point tracker) forming part of the controller is used to provide the maximum power output that can be obtained based on the fluctuating voltage produced by the panels of the source 24.

A threshold is set in the programmable controller. When the maximum power that can be obtained by manipulation of the d.c. voltage and the current available from the panels falls below the set threshold, the connection between the output side of the MPPT and the element 10 is terminated. After a predetermined delay the source 14 is connected to the element 10.

When the output voltage of the MPPT increases to above the set threshold, the reverse occurs. The mains source 14 is disconnected from the element 10 and, after a delay, the source 24 is reconnected to the element 10.

It is also possible to convert the d.c. output of the MPPT into a wave form that simulates high frequency a.c. before feeding it to the element 10 thereby to provide a wave form which can be switched without excessive arcing. This avoids the need for any components that operate on d.c., and which components are in general more expensive than equivalent components which operate on a.c.

1. A power supply system for powering a resistive element, the system comprising:
a first power input point for connection to an a.c mains supply;
first terminals for connection to said element;
a first switch having a closed position in which said input point is connected to said terminals and an open position in which said input point is disconnected from said terminals;
a first timer for delaying closure of said first switch;
a second power input point for connection to a d.c source of electrical energy;
second terminals for connection to said element;
means for converting the d.c input at said second power input point to a.c power at said second terminals;
a second switch having a closed position in which said converting means is connected to said second terminals and an open position in which said converting means is disconnected from the second terminals;
a second timer for delaying closure of said second switch; and
a control circuit for detecting the presence of voltage at said second power input point and, upon the d.c voltage being detected being above a predetermined threshold level, in sequence opening said first switch and closing said second switch.

2. A power supply system as claimed in claim 1, wherein said control circuit comprises a light source which is supplied with power when the detected voltage exceeds said threshold level and a light sensitive switch which is actuated upon the light source being powered.

3. A power supply system as claimed in claim 2, and including an opto-coupler between said light source and said second power input point.

4. A power supply system as claimed in any preceding claim 1 and including a two pole relay which is connected between said first power input point and said timers and which is switched between its two positions in dependence on whether said detected voltage is above or below said threshold level.

5. (canceled)

6. A power supply system as claimed in claim 1 in which said first and second switches include operating coils connected through the first and second timers to said first power input point.

7. A power supply system as claimed in claim 1, and including a maximum power point tracker for providing the optimum power output based on the voltage and current at said second power input point, switching between mains power and d.c power being dependent on whether the power output of the tracker is above or below a predetermined threshold.

8. A power supply system as claimed in claim 7, and including means for converting the output of the tracker to a wave form which simulates a.c.

9. An installation comprising a hot water cylinder having a resistive heating element therein, and a power supply system as claimed in claim 1, said first and second terminals being connected to said element, said first power input point being connected to the mains and the second power input point being connected to a source of wind and/or solar generated d.c voltage.

10. A method of supplying power to a resistive element, the method comprising monitoring the voltage available from photovoltaic panels and/or wind generators constituting a d.c source of power, connecting the d.c source to the element to power the element when the voltage available exceeds a predetermined threshold, disconnecting the d.c source from the element when the voltage available falls below said threshold and connecting, after a delay period, a source of mains power to the element to power the element, disconnecting the mains power from the element upon the available d.c voltage exceeding said threshold and, after a delay, re-connecting the d.c. source to the element to power the element.
